(19) United States
(12) Patent Application Publication
(10) Pub. No.: US 2020/0185990 A1
(43) Pub. Date: Jun. 11, 2020

(54) ROTOR AND MANUFACTURING METHOD OF ARC MAGNET FOR ROTOR

(71) Applicant: HONDA MOTOR CO., LTD., Tokyo (JP)

(72) Inventors: Shingo SOMA, Saitama (JP); Yoshihisa KUBOTA, Saitama (JP); Tatsuya OHZU, Saitama (JP)

(73) Assignee: HONDA MOTOR CO., LTD., Tokyo (JP)

(21) Appl. No.: 16/704,085

(22) Filed: Dec. 5, 2019

(30) Foreign Application Priority Data
Dec. 10, 2018 (JP) 2018-231024

(51) Int. Cl. H02K 1/27; H02K 15/03

(52) U.S. Cl. CPC H02K 1/2766; H02K 15/03

(57) ABSTRACT

A rotor includes: a rotor core including a plurality of magnet insertion holes provided along the circumferential direction; and a plurality of magnetic pole portions constituted by arc magnets inserted into the magnet insertion holes. The arc magnet, constituting each magnetic pole portion, is arranged to protrude inward of the rotor core in the radial direction, and has thick portions protruding to the outer peripheral surface at both circumferential end portions of the outer peripheral surface.

### CROSS-REFERENCE TO RELATED APPLICATIONS

The present application claims the benefit of priority of Japanese Patent Application No. 2018-231024, filed on Dec. 10, 2018, the content of which is incorporated herein by reference.

### TECHNICAL FIELD

The present invention relates to a rotor used in a rotating electrical machine and a manufacturing method of an arc magnet for a rotor.

### BACKGROUND ART

In the related art, as a rotor used in a rotating electrical machine, a rotor in which a plurality of permanent magnets are arranged at predetermined intervals in the circumferential direction inside a rotor core is known. For example, JP-A-H09-233744 discloses a rotor for a rotating electrical machine, which includes a magnetic pole portion in which an arc magnet located on the outer diameter side of the rotor and an arc magnet located on the inner diameter side of the rotor have substantially the same plate thickness and are arranged in a substantially concentric circle shape.

In a rotor of a rotating electrical machine, it is known that both end portions in the circumferential direction of a permanent magnet inserted into a magnet insertion hole are easily demagnetized because a short-circuit magnetic flux is generated. In the rotor of JP-A-H09-233744, demagnetization occurs at both end portions in the circumferential direction of the outer circumferential surface of the arc magnet, which causes a problem that the permeance coefficient of the entire arc magnet decreases.

### SUMMARY

The present invention provides a rotor and a manufacturing method of an arc magnet for a rotor that can suppress demagnetization of the arc magnet and further, can improve the permeance coefficient of the entire arc magnet.

According to an aspect of the present invention, there is provided a rotor including: a rotor core including a plurality of magnet insertion holes provided along the circumferential direction; and a plurality of magnetic pole portions constituted by arc magnets inserted into the magnet insertion holes, wherein: the arc magnet, constituting each magnetic pole portion, is arranged to protrude inward of the rotor core in the radial direction; and the arc magnet, constituting each magnetic pole portion, has thick portions protruding to the outer peripheral surface at both circumferential end portions of the outer peripheral surface.

According to another aspect of the present invention, there is provided a manufacturing method of an arc magnet for a rotor, including: forming a ring magnet having a plurality of thick portions protruding from the outer peripheral surface to the outer peripheral side; and cutting the ring magnet in a radial direction at the plurality of thick portions.

### Effects

According to the present invention, since the wall thickness of both end portions in the circumferential direction of the outer peripheral surface of the arc magnet that is easily demagnetized is increased, demagnetization of the arc magnet can be suppressed, and further, the permeance coefficient of the entire arc magnet can be improved.

### BRIEF DESCRIPTION OF THE DRAWINGS

FIG. 1 is a front view of a rotor of one embodiment of the present invention;

FIG. 2 is an enlarged view around a magnetic pole portion of the rotor of FIG. 1;

FIG. 3A is a diagram illustrating an outer diameter side arc magnet of the rotor of FIG. 1;

FIG. 3B is a diagram illustrating an inner diameter side arc magnet of the rotor of FIG. 1; and

FIG. 4 is a diagram illustrating a ring magnet formed when an arc magnet used for the rotor of one embodiment of the present invention, and an arc magnet formed from the ring magnet.

### DESCRIPTION OF EMBODIMENTS

Hereinafter, an embodiment of a rotor of the present invention will be described with reference to the accompanying drawings.

### [Overall Configuration of Rotor]

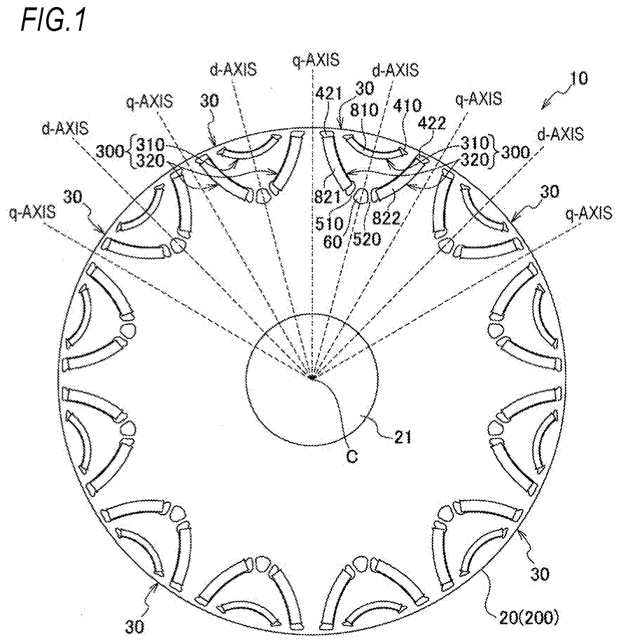

As illustrated in FIG. 1, a rotor 10 of a rotating electrical machine of one embodiment includes a rotor core 20 attached to an outer peripheral portion of a rotor shaft (not illustrated), and a plurality of magnetic pole portions 30 (12 in this embodiment) formed inside the rotor core 20 at predetermined intervals in the circumferential direction, and the rotor 10 is arranged on the inner peripheral side of a stator (not illustrated).

The rotor core 20 is formed by laminating a plurality of substantially annular electromagnetic steel plates 200 having the same shape in the axial direction. The rotor core 20 includes a rotor shaft hole 21 concentric with an axial center C. Furthermore, when the central axis of each magnetic pole portion 30, which connects the axial center C and the center of each magnetic pole portion 30, is set as the d-axis (d-axis in the drawing) and the axis separated from the d-axis by 90 electrical degrees is set as the q-axis (q-axis in the drawing), the rotor core 20 includes an outer diameter side magnet insertion hole 410 formed on the outer diameter side of the rotor core 20 so as to cross the d-axis; a pair of inner diameter side magnet insertion holes 421 and 422 formed in a substantially V-shape extending outward in the radial direction across the d-axis on the inner diameter side of the outer diameter side magnet insertion hole 410; a pair of ribs 510 and 520 formed in the d-axis side end portions of the inner diameter side magnet insertion holes 421 and 422 and respectively extending in the radial direction; and a gap portion 60 formed between the pair of ribs 510 and 520, so as to correspond to each magnetic pole portion 30. Each of the outer diameter side magnet insertion hole 410 and the inner diameter side magnet insertion holes 421 and 422 has an arc shape that protrudes radially inward.

Each magnetic pole portion 30 includes a magnet part 300 including an outer diameter side magnet part 310 and an inner diameter side magnet part 320. The outer diameter side magnet part 310 is configured by an outer diameter side arc magnet 810 that is inserted into the outer diameter side magnet insertion hole 410 and arranged to protrude radially inward. The inner diameter side magnet part 320 is configured by a pair of inner diameter side arc magnets 821 and 822 that are inserted into the pair of inner diameter side magnet insertion holes 421 and 422, respectively, and arranged to protrude radially inward.

The outer diameter side arc magnet 810 and the pair of inner diameter side arc magnets 821 and 822 are magnetized in the radial direction. Also, the outer diameter side arc magnet 810 and the pair of inner diameter side arc magnets 821 and 822 are arranged so that the magnetization directions thereof are different from that of the adjacent magnetic pole portion 30, and the magnetization directions of the magnetic pole portions 30 are alternately different in the circumferential direction.

Here, in the front view of the rotor 10, when the axial center C is set as the lower side and the outer diameter side in the d-axis direction is set as the upper side, the pair of inner diameter side magnet insertion holes 421 and 422 are arranged with a first inner diameter side magnet insertion hole 421 on the left side and a second inner diameter side magnet insertion hole 422 on the right side with respect to the d-axis, and the pair of ribs 510 and 520 are arranged with a first rib 510 on the left side and a second rib 520 on the right side across the d-axis. The pair of inner diameter side arc magnets 821 and 822 are arranged with a first inner diameter side arc magnet 821 on the left side and a second inner diameter side arc magnet 822 on the right side across the d-axis.

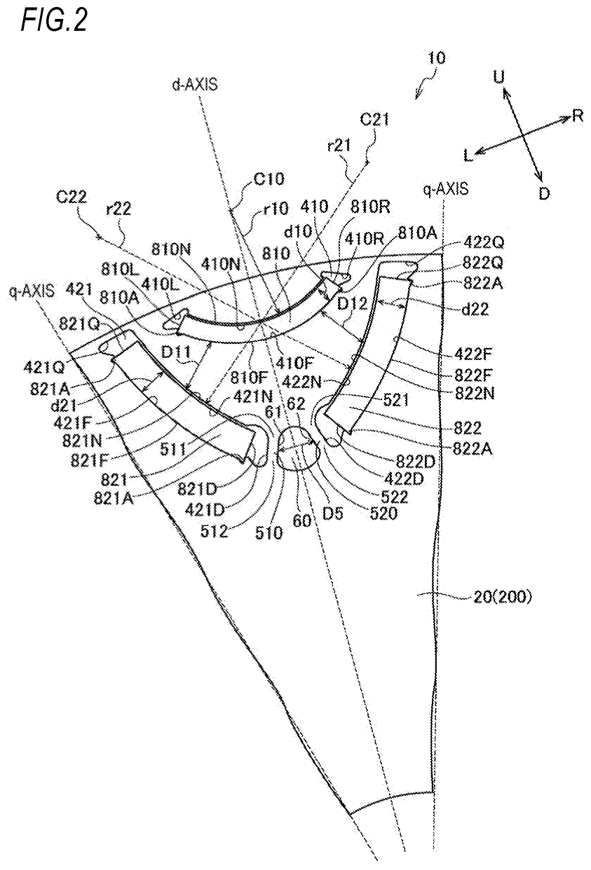

Hereinafter, in the present specification and the like, in order to simplify and clarify the description, in the front view of the rotor 10, the axial center C is defined as the lower side and the outer diameter side in the d-axis direction is defined as the upper side. In FIG. 2, the upper side of the rotor 10 is indicated as U, the lower side as D, the left side as L, and the right side as R.

### [Configuration of Magnetic Pole Portion]

As illustrated in FIG. 2, the outer diameter side arc magnet 810 includes an inner peripheral surface 810N and an outer peripheral surface 810F having the same arc center C10, a left side end surface 810L, and a right side end surface 810R.

The first inner diameter side arc magnet 821 includes an inner peripheral surface 821N and an outer peripheral surface 821F having the same arc center C21, a q-axis side end surface 821Q, and a d-axis side end surface 821D. The arc center C21 of the first inner diameter side arc magnet 821 is located on the right side opposite to the first inner diameter side arc magnet 821 with respect to the d-axis.

The second inner diameter side arc magnet 822 includes an inner peripheral surface 822N and an outer peripheral surface 822F having the same arc center C22, a q-axis side end surface 822Q, and a d-axis side end surface 822D. The arc center C22 of the second inner diameter side arc magnet 822 is located on the left side opposite to the second inner diameter side arc magnet 822 with respect to the d-axis.

Both a distance D11 between the first inner diameter side arc magnet 821 and the outer diameter side arc magnet 810 and a distance D12 between the second inner diameter side arc magnet 822 and the outer diameter side arc magnet 810 increase as closer from the q-axis to the d-axis.

As a result, since the increase in the length of the magnetic pole portion 30 in the circumferential direction can be suppressed, the increase in the size of the rotor 10 can be suppressed. Therefore, when increasing the magnet amount of the first inner diameter side arc magnet 821 and the second inner diameter side arc magnet 822, the rotor 10 can use the outer diameter side arc magnet 810, the first inner diameter side arc magnet 821 and the second inner diameter side arc magnet 822 having high-performance magnetization characteristics while suppressing an increase in size. In addition, since the magnetic path along the q-axis in the rotor 10 (hereinafter, also referred to as the q-axis magnetic path) can be widened and the reluctance torque of the rotating electrical machine can be increased, the output performance of the rotating electrical machine can be improved. Furthermore, the magnetic flux due to the first inner diameter side arc magnet 821 and the second inner diameter side arc magnet 822, and the outer diameter side arc magnet 810 is easily concentrated on the d-axis, and the magnet torque of the rotating electrical machine can be efficiently used. The output performance of the rotating electrical machine can be improved.

The arc center C10 of the outer diameter side arc magnet 810 is located on the d-axis. As a result, the outer diameter side magnet part 310 can be configured with a single arc magnet, and further, the outer diameter side magnet part 310 can be formed symmetrically with respect to the d-axis. Therefore, the magnet torque can be efficiently obtained with a simple structure.

Further, the arc center C21 of the first inner diameter side arc magnet 821 and the arc center C22 of the second inner diameter side arc magnet 822 are located symmetrically with respect to the d-axis. Accordingly, since the inner diameter side magnet part 320 can be formed symmetrically with respect to the d-axis, an efficient arrangement for obtaining reluctance torque can be achieved.

The outer diameter side magnet insertion hole 410 includes an inner peripheral wall surface 410N and an outer peripheral wall surface 410F formed along the inner peripheral surface 810N and the outer peripheral surface 810F of the outer diameter side arc magnet 810, a left side wall surface 410L, and a right side wall surface 410R. The first inner diameter side magnet insertion hole 421 includes an inner peripheral wall surface 421N and an outer peripheral wall surface 421F formed along the inner peripheral surface 821N and the outer peripheral surface 821F of the first inner diameter side arc magnet 821, a q-axis side wall surface 421Q, and a d-axis side wall surface 421D. The second inner diameter side magnet insertion hole 422 includes an inner peripheral wall surface 422N and an outer peripheral wall surface 422F formed along the inner peripheral surface 822N and the outer peripheral surface 822F of the second inner diameter side arc magnet 822, a q-axis side wall surface 422Q, and a d-axis side wall surface 422D.

Further, a first rib 510 extending in the radial direction is formed between the d-axis side end surface 821D of the first inner diameter side arc magnet 821 and the d-axis, and a second rib 520 extending in the radial direction is formed between the d-axis side end surface 822D of the second inner diameter side arc magnet 822 and the d-axis. Further, the gap portion 60 is formed between the first rib 510 and the second rib 520. Therefore, the gap portion 60 is provided to overlap the d-axis.

As a result, in the inner diameter side magnet part 320, a gap is formed on the d-axis, and thus, the d-axis inductance can be reduced. Therefore, since the difference between the d-axis inductance and the q-axis inductance can be increased, the reluctance torque can be used effectively, and the output performance of the rotating electrical machine can be improved.

The first rib 510 is constituted by the d-axis side wall surface 421D of the first inner diameter side magnet insertion hole 421 and a left side wall surface 61 of the gap portion 60. The second rib 520 is constituted by the d-axis side wall surface 422D of the second inner diameter side magnet insertion hole 422 and a right side wall surface 62 of the gap portion 60.

Therefore, the first rib 510 receives a centrifugal load by the first inner diameter side arc magnet 821, and the second rib 520 receives a centrifugal load by the second inner diameter side arc magnet 822. That is, the first rib 510 and the second rib 520 separately receive the centrifugal load from the first inner diameter side arc magnet 821 and the centrifugal load from the second inner diameter side arc magnet 822, respectively. As a result, the bending stress generated in the rotor core 20 due to the weight variation of the first inner diameter side arc magnet 821 and the second inner diameter side arc magnet 822 can be reduced.

Further, the first rib 510 and the second rib 520 are provided in a substantially V shape in which a distance D5 between the first rib 510 and the second rib 520 increases toward the inner side in the radial direction. As a result, a radially outer side end portion 511 and a radially inner side end portion 512 of the first rib 510 and a radially outer side end portion 521 and a radially inner side end portion 522 of the second rib 520 both can increase an angle R. Therefore, the stress concentration at both end portions in the radial direction of the first rib 510 and the second rib 520 can be reduced.

Here, the gap portion 60 may be supplied with a refrigerant. Thus, since the refrigerant can be supplied in the vicinity of the outer diameter side arc magnet 810, the first inner diameter side arc magnet 821 and the second inner diameter side arc magnet 822, it is possible to cool the outer diameter side arc magnet 810, the first inner diameter side arc magnet 821 and the second inner diameter side arc magnet 822 more effectively.

### [Shape of Arc Magnet]

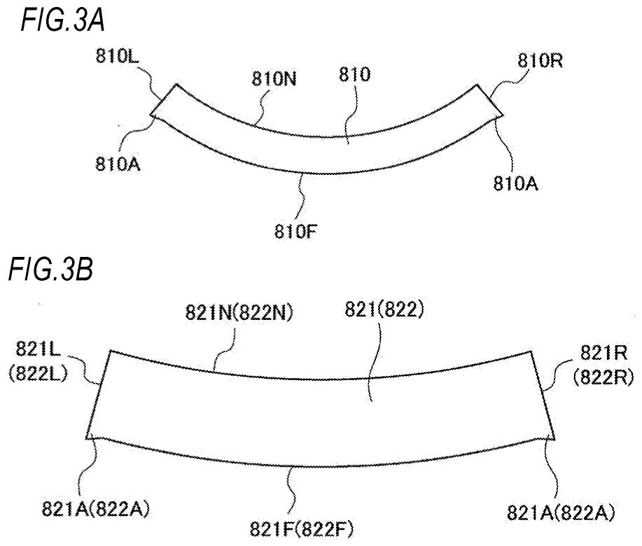

As illustrated in FIG. 3A, both end portions in the circumferential direction of the outer peripheral surface 810F of the outer diameter side arc magnet 810 have thick portions 810A protruding to the outer circumferential side. The thick portion 810A of the outer peripheral surface 810F of the outer diameter side arc magnet 810 becomes thicker as closer to the left side end surface 810L and the right side end surface 810R.

As illustrated in FIG. 3B, both end portions in the circumferential direction of the outer peripheral surface 821F of the first inner diameter side arc magnet 821 have thick portions 821A protruding to the outer circumferential side. The thick portion 821A of the outer peripheral surface 821F of the first inner diameter side arc magnet 821 becomes thicker as closer to the q-axis side end surface 821Q and the d-axis side end surface 821D. Similarly, both end portions in the circumferential direction of the outer peripheral surface 822F of the second inner diameter side arc magnet 822 have thick portions 822A protruding to the outer circumferential side. The thick portion 822A of the outer peripheral surface 822F of the second thick-side arc magnet 822 becomes thicker as closer to the q-axis side end surface 822Q and the d-axis side end surface 822D.

Referring back to FIG. 2, the outer diameter side arc magnet 810, the first inner diameter side arc magnet 821, and the second inner diameter side arc magnet 822 include the thick portions 810A, 821A, and 822A protruding to the outer circumferential side at both end portions in the circumferential direction of the outer peripheral surfaces 810F, 821F, and 822F. As a result, the outer diameter side arc magnet 810, the first inner diameter side arc magnet 821, and the second inner diameter side arc magnet 822 all have a thick thickness at both end portions in the circumferential direction which are most likely to be demagnetized, and therefore, the demagnetization can be suppressed. Further, by suppressing demagnetization at both end portions in the circumferential direction of the outer diameter side arc magnet 810, the first inner diameter side arc magnet 821, and the second inner diameter side arc magnet 822, the permeance coefficient of each arc magnet 810, 821 and 822 as a whole is improved.

Further, the thick portions 810A, 821A, and 822A of the outer diameter side arc magnet 810, the first inner diameter side arc magnet 821, and the second inner diameter side arc magnet 822 become thicker toward both end surfaces in the circumferential direction. Therefore, the demagnetization of the arc magnet can be more effectively suppressed.

### [Manufacture of Arc Magnets]

The outer diameter side arc magnet 810, the first inner diameter side arc magnet 821, and the second inner diameter side arc magnet 822 are manufactured by a ring magnet forming process and a cutting process of cutting the ring magnet formed by the ring magnet forming process in the radial direction.

### (Ring Magnet Forming Process)

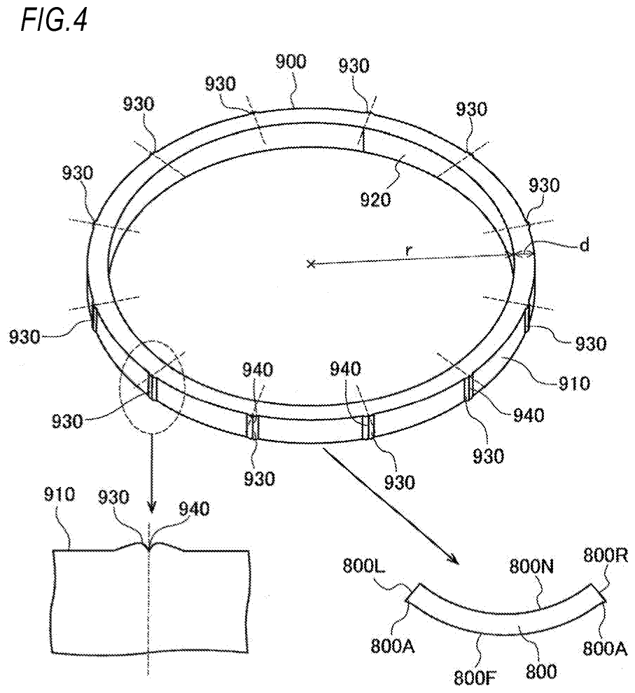

As illustrated in FIG. 4, a ring magnet 900 is formed by a ring magnet forming process. The ring magnet 900 includes an annular outer peripheral surface 910 and an annular inner peripheral surface 920. The ring magnet 900 includes a plurality of thick portions 930 that protrude from the outer peripheral surface 910 to the outer circumferential side at predetermined intervals. Further, a notch portion 940 that is recessed in a substantially V shape is formed on the outer peripheral surface 910 of the thick portion 930. In the present embodiment, the notch portion 940 is formed on the outer peripheral surface 910 of the thick portion 930, but may be formed on the inner peripheral surface 920 of the thick portion 930.

The ring magnet 900 is formed by hot working. For example, the ring magnet 900 is formed by hot extrusion molding. By hot extrusion molding, radially compressive stress acts on the crystal group of the ring magnet material that has been randomly oriented, and the crystal group of the ring magnet material is oriented in the same direction as the compressive stress direction. As a result, an anisotropic ring magnet 900 oriented in the radial direction is obtained.

Here, the ring magnet 900 having the thick portion 930 and the notch portion 940 can be formed by shaping a mold on the outer peripheral surface side used for hot extrusion molding along the shape of the thick portion 930 and the notch portion 940.

After forming a ring magnet having the thick portion 930 such that the mold on the outer peripheral surface side used for hot extrusion molding is shaped along the shape of the thick portion 930, a notch portion forming process for forming the notch portion 940 that is recessed in a substantially V shape by laser processing, machine processing, or the like may be provided on at least one of the outer peripheral surface 910 and the inner peripheral surface 920 of the thick portion 930.

### (Cutting Process)

Through a cutting process, the ring magnet 900 is cut at the notch portion 940 in the radial direction to form the arc magnet 800. The arc magnet 800 includes an inner peripheral surface 800N and an outer peripheral surface 800F, and a first end surface 800L and a second end surface 800R which are cut surfaces and form both end portions in the circumferential direction. Since the notch portion 940 is formed in the thick portion 930, the arc magnet 800 includes a thick portion 800A protruding to the outer peripheral side at both circumferential end portions of the outer peripheral surface 800F. Furthermore, the thick portion 800A of the outer peripheral surface 800F of the arc magnet 800 becomes thicker as closer to the first end surface 800L and the second end surface 800R.

The arc magnet 800 is formed by cutting the ring magnet 900 at the notch portion 940 in the radial direction.

Since the crystal group of the magnet material of the ring magnet 900 formed by hot working has anisotropy and is easily cleaved in the radial direction, the ring magnet 900 is easily divided in the radial direction from the notch portion 940. Therefore, by dividing the ring magnet 900 from the notch portion 940 in the radial direction, the ring magnet 900 can be cut at the notch portion 940 in the radial direction, and the arc magnet 800 is formed. As a result, the ring magnet 900 can be cut in a shorter time than when the ring magnet 900 is cut at the notch portion 940 in the radial direction by wire cutting or the like to form the arc magnet 800.

Here, in order to obtain the ring magnet 900 having high-performance magnetization characteristics, it is desirable that the stress acting on the crystal group of the ring magnet material be uniform over the entire area. However, if the ring radius r of the ring magnet 900 is small and the all thickness d of the ring magnet 900 is large, the stress acting on the crystal group of the ring magnet material becomes uneven in the hot working process of the ring magnet forming process and the degree of orientation of the ring magnet 900 is lowered. In addition, even when the wall thickness d of the ring magnet 900 is not uniform, the stress acting on the crystal group of the ring magnet material becomes uneven in the hot working process of the ring magnet forming process, and the degree of orientation of the ring magnet 900 is lowered. Therefore, in order for the stress acting on the crystal group of the ring magnet material to be uniform over the entire area, the value of (the wall thickness d of the ring magnet 900)/(the ring radius r of the ring magnet 900) needs to be within a predetermined range. That is, in order to obtain the arc magnet 800 having high-performance magnetization characteristics, it is necessary to increase the ring radius r of the ring magnet 900 in accordance with the wall thickness d of the ring magnet 900.

Therefore, by forming the ring magnet 900 with a setting of the wall thickness d of the ring magnet 900 and the ring radius r of the ring magnet 900 to have the value of (the wall thickness d of the ring magnet 900)/(the ring radius r of the ring magnet 900) within a predetermined range, it is possible to obtain the outer diameter side arc magnet 810, the first inner diameter side arc magnet 821, and the second inner diameter side arc magnet 822 having high-performance magnetization characteristics.

Referring back to FIG. 2, a plate thickness d21 of the first inner diameter side arc magnet 821 and a plate thickness d22 of the second inner diameter side arc magnet 822 are larger than a plate thickness d10 of the outer diameter side arc magnet 810. Thus, since the magnet amount of the first inner diameter side arc magnet 821 and the second inner diameter side arc magnet 822 can be increased and the magnet torque of the rotating electrical machine can be increased, the output performance of the rotating electrical machine can be improved.

Further, by increasing the plate thickness d21 of the first inner diameter side arc magnet 821 and the plate thickness d22 of the second inner diameter side arc magnet 822, an arc radius r21 of the inner peripheral surface 821N of the first inner diameter side arc magnet 821 and an arc radius r22 of the inner peripheral surface 822N of the second inner diameter side arc magnet 822 become larger than an arc radius r10 of the inner peripheral surface 810N of the outer diameter side arc magnet 810. Thus, since the outer diameter side arc magnet 810, the first inner diameter side arc magnet 821, and the second inner diameter side arc magnet 822 having high-performance magnetization characteristics can be used, the output performance of the rotating electrical machine can be improved.

Here, preferably, d10/r10 which is the ratio of the arc radius r10 of the inner peripheral surface 810N of the outer diameter side arc magnet 810 and the plate thickness d10 of the outer diameter side arc magnet 810, d21/r21 which is the ratio of the arc radius r21 of the inner peripheral surface 821N of the first inner diameter side arc magnet 821 and the plate thickness d21 of the first inner diameter side arc magnet 821, and d22/r22 which is the ratio of the arc radius r22 of the inner peripheral surface 822N of the second inner diameter side arc magnet 822 and the plate thickness d22 of the second inner diameter side arc magnet 822 are substantially the same value within a predetermined range. More preferably, the arc radius r21 of the inner peripheral surface 821N of the first inner diameter side arc magnet 821 and the arc radius r22 of the inner peripheral surface 822N of the second inner diameter side arc magnet 822 are the same, and the plate thickness d21 of the first inner diameter side arc magnet 821 and the plate thickness d22 of the second inner diameter side arc magnet 822 are the same, and further, the first inner diameter side arc magnet 821 and the second inner diameter side arc magnet 822 have the same shape.

Thus, in the rotor 10, when increasing the magnet amount of the first inner diameter side arc magnet 821 and the second inner diameter side arc magnet 822, the outer diameter side arc magnet 810, the first inner diameter side arc magnet 821 and the second inner diameter side arc magnet 822 having high-performance magnetization characteristics can be used, and the output performance of the rotating electrical machine can be improved.

In addition, the present invention is not limited to the embodiment described above, and a modification, improvement, and the like can be made as appropriate.

For example, the first inner diameter side arc magnet 821 and the second inner diameter side arc magnet 822 of the inner diameter side magnet part 320 can be omitted. That is, the magnet part 300 may be configured only by the outer diameter side arc magnet 810 of the outer diameter side magnet part 310. On the other hand, the magnet part 300 may omit the outer diameter side magnet part 310, and may be configured only by the first inner diameter side arc magnet 821 and the second inner diameter side arc magnet 822 of the inner diameter side magnet part 320.

In addition, at least the following matters are described in this specification. In addition, although the corresponding components and the like in the above-described embodiment are illustrated in parenthesis, the present invention is not limited thereto.

(1) A rotor (rotor 10) including a rotor core (rotor core 20) including a plurality of magnet insertion holes (outer diameter side magnet insertion hole 410) provided along the circumferential direction; and

a plurality of magnetic pole portions (magnetic pole portions 30) constituted by arc magnets (outer diameter side arc magnets 810) inserted into the magnet insertion holes; in which

the arc magnet constituting each magnetic pole portion

is arranged to protrude inward of the rotor core in the radial direction, and

has thick portions (thick portions 810A) protruding to the outer peripheral side at both circumferential end portions of the outer peripheral surface (outer peripheral surface 810 F).

According to (1), since the wall thickness of both end portions in the circumferential direction of the arc magnet that is easily demagnetized is increased, demagnetization of the arc magnet can be suppressed, and further, the permeance coefficient of the entire arc magnet can be improved.

(2) The rotor according to (1), in which

the thick portion has a thicker wall thickness as closer to both end surfaces in the circumferential direction (left side end surface 810L and right side end surface 810R) of the arc magnet.

According to (2), since the wall thickness increases as closer to both end surfaces in the circumferential direction of the arc magnet, demagnetization of the arc magnet can be further suppressed.

(3) The rotor according to (1) or (2), in which

each magnetic pole portion includes

at least two layers of magnet parts (magnet parts 300) along the radial direction;

the magnet part includes

an outer diameter side magnet part (outer diameter side magnet part 310) which is constituted of at least one arc magnet (outer diameter side arc magnet 810) arranged so as to protrude inward in the radial direction, and

an inner diameter side magnet part (inner diameter side magnet part 320) which is constituted of at least a pair of arc magnets (inner diameter side arc magnets 821 and 822) arranged so as to protrude inward in the radial direction;

each arc magnet has an inner peripheral surface and an outer peripheral surface having the same arc center (arc centers C10, C21 and C22);

the plate thickness of the arc magnet (plate thickness d10, d21 and d22) is thicker in the inner diameter side magnet part than in the outer diameter side magnet part; and

the arc radius of the arc magnet (arc radiuses r10, r21 and r22) is larger in the inner diameter side magnet part than in the outer diameter side magnet part.

According to (3), the plate thickness and arc radius of the arc magnet are larger in the inner diameter side magnet part than in the outer diameter side magnet part. That is, the arc radius of the arc magnet can be increased by increasing the plate thickness of the arc magnet of the inner diameter side magnet part more than the plate thickness of the arc magnet of the outer diameter side magnet part. Therefore, when increasing the magnet amount in each magnetic pole portion, it is possible to use an arc magnet having high-performance magnetization characteristics, and the output performance of the rotating electrical machine can be improved.

(4) The rotor according to (3), in which

when the central axis of each magnetic pole portion is d-axis, and the axis separated from the d-axis by 90 electrical degrees is q-axis, the distance (distances D11 and D12) between the arc magnet of the inner diameter side magnet part and the arc magnet of the outer diameter side magnet part increases as closer to the d-axis from the q-axis.

According to (4), the distance between the arc magnet of the inner diameter side magnet part and the arc magnet of the outer diameter side magnet part increases as closer to the d-axis from the q-axis. As a result, since it is possible to suppress the length of a magnetic pole portion in the circumferential direction from becoming large, an increase in the size of the rotor can be suppressed. In addition, since the q-axis magnetic path can be widened, the reluctance torque of the rotating electrical machine can be increased. Furthermore, since the magnetic flux generated by the arc magnet of the inner diameter side magnet part and the arc magnet of the outer diameter side magnet part is easily concentrated on the d-axis, the magnet torque of the rotating electrical machine can be used efficiently.

(5) A manufacturing method of an arc magnet (arc magnet 800) for a rotor, including

a ring magnet forming process for forming a ring magnet (ring magnet 900) having a plurality of thick portions (thick portions 930) protruding from the outer peripheral surface (outer peripheral surface 910) to the outer peripheral side; and

a cutting process for cutting the ring magnet in a radial direction at the plurality of thick portions.

According to (5), it is possible to efficiently manufacture an arc magnet for a rotor having a thick portion protruding toward the outer peripheral side at the circumferential end portion of the outer peripheral surface.

(6) The manufacturing method of an arc magnet for a rotor according to (5), in which

the ring magnet forming process forms the ring magnet by hot working.

According to (6), since the ring magnet is formed by hot working, an arc magnet for a rotor having high-performance magnetization characteristics can be manufactured.

(7) The manufacturing method of an arc magnet for a rotor according to (6), in which

a notch portion forming process for forming a notch portion (notch portion 940) on at least one of the inner peripheral surface (inner peripheral surface 920) and the outer peripheral surface of the ring magnet in the plurality of thick portions is included between the ring magnet forming process and the cutting process, and

the cutting process cuts the ring magnet in the radial direction at the notch portions formed in the plurality of thick portions.

According to (7), since the crystal group of the magnet material of the ring magnet formed by hot working has anisotropy and is easily cleaved in the radial direction, the ring magnet can be easily cut in the radial direction at the notch portion in the cutting process by forming the notch portion on at least one of the inner peripheral surface and the outer peripheral surface of the ring magnet in the thick portion. Thus, an arc magnet having a thick portion protruding toward the outer peripheral side in the circumferential end portion of the outer peripheral surface can be manufactured more efficiently.

(8) The manufacturing method of an arc magnet for a rotor according to (6), in which

in the ring magnet forming process, a notch portion (notch portion 940) is formed on at least one of the inner peripheral surface (inner peripheral surface 920) and the outer peripheral surface of the ring magnet in the plurality of thick portions, and

the cutting process cuts the ring magnet in the radial direction at the notch portions formed in the plurality of thick portions.

According to (8), since the crystal group of the magnet material of the ring magnet formed by hot working has anisotropy and is easily cleaved in the radial direction, the ring magnet can be easily cut in the radial direction at the notch portion in the cutting process by forming the notch portion on at least one of the inner peripheral surface and the outer peripheral surface of the ring magnet in the thick portion. Thus, an arc magnet having the thick portion protruding to the outer peripheral side in the circumferential end portion of the outer peripheral surface can be manufactured more efficiently.

Furthermore, since the notch portion is formed in the ring magnet forming process, the manufacturing processes of the arc magnet for a rotor can be reduced.

1. A rotor comprising:
a rotor core including a plurality of magnet insertion holes provided along the circumferential direction; and
a plurality of magnetic pole portions constituted by arc magnets inserted into the magnet insertion holes, wherein:
the arc magnet, constituting each magnetic pole portion, is arranged to protrude inward of the rotor core in the radial direction; and
the arc magnet, constituting each magnetic pole portion, has thick portions protruding to the outer peripheral surface at both circumferential end portions of the outer peripheral surface.

2. The rotor according to claim 1, wherein
the thick portion has a thicker wall thickness as closer to both end surfaces in the circumferential direction of the arc magnet.

3. The rotor according to claim 1, wherein:
each magnetic pole portion includes at least two layers of magnet parts along the radial direction;
the magnet part includes:
an outer diameter side magnet part which is constituted of at least one arc magnet arranged so as to protrude inward in the radial direction; and
an inner diameter side magnet part which is constituted of at least a pair of arc magnets arranged so as to protrude inward in the radial direction;
each arc magnet has an inner peripheral surface and an outer peripheral surface having the same arc center;
the plate thickness of the arc magnet is thicker in the inner diameter side magnet part than in the outer diameter side magnet part; and
the arc radius of the arc magnet is larger in the inner diameter side magnet part than in the outer diameter side magnet part.

4. The rotor according to claim 3, wherein
when the central axis of each magnetic pole portion is d-axis, and the axis separated from the d-axis by 90 electrical degrees is q-axis, the distance between the arc magnet of the inner diameter side magnet part and the arc magnet of the outer diameter side magnet part increases as closer to the d-axis from the q-axis.

5. A manufacturing method of an arc magnet for a rotor, comprising:
forming a ring magnet having a plurality of thick portions protruding from the outer peripheral surface to the outer peripheral side; and
cutting the ring magnet in a radial direction at the plurality of thick portions.

6. The manufacturing method of an arc magnet for a rotor according to claim 5, wherein
the ring magnet is formed by hot working.

7. The manufacturing method of an arc magnet for a rotor according to claim 6, further comprising:
forming a notch portion on at least one of the inner peripheral surface and the outer peripheral surface of the ring magnet in the plurality of thick portions is included between the forming of the ring magnet and the cutting of the ring magnet, wherein
the ring magnet is cut in the radial direction at the notch portions formed in the plurality of thick portions.

8. The manufacturing method of an arc magnet for a rotor according to claim 6, wherein:
when the ring magnet is formed, a notch portion is formed on at least one of the inner peripheral surface and the outer peripheral surface of the ring magnet in the plurality of thick portions; and
the ring magnet is cut in the radial direction at the notch portions formed in the plurality of thick portions.
